(19) United States
(12) Patent Application Publication
(10) Pub. No.: US 2015/0067316 A1
(43) Pub. Date: Mar. 5, 2015

(54) ELECTRONIC DEVICE AND TESTING METHOD

(71) Applicants: HON HAI PRECISION INDUSTRY CO., LTD., New Taipei (TW); HONG FU JIN PRECISION INDUSTRY (ShenZhen) CO.,LTD., Shenzhen (CN)

(72) Inventor: WEN-JIE ZHANG, Shenzhen (CN)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/133,481

(22) Filed: Dec. 18, 2013

(30) Foreign Application Priority Data
Aug. 29, 2013 (CN) 2013103852808

(51) Int. Cl. G06F 21/57

(52) U.S. Cl. CPC G06F 21/572
USPC 713/2

(57) ABSTRACT

In a method of testing stability of updating firmware of a baseboard management controller (BMC) of an electronic device, the electronic device comprises a first storage device that stores original firmware data of the BMC, and a second storage device that stores update data of the firmware. The electronic device tests the stability by repeatedly erasing the original firmware data and writing the update data into the first storage device. Once the electronic device updates the firmware of the BMC for a predetermined number of times, the process is ended.

### BACKGROUND

1. Technical Field

Embodiments of the present disclosure relates to testing technology, and more particularly to an electronic device and a method for testing stability of updating firmware of a Baseboard Management Controller (BMC) of the electronic device.

2. Description of Related Art

A BMC acts as a monitoring unit of an electronic device (e.g., a server or a computer). It is important to test the BMC for ensuring performance of the electronic device. However, most of tests on the BMC are performed manually, which is often inefficient and inconvenient. Therefore, an improved method for testing the BMC is desired.

### BRIEF DESCRIPTION OF THE DRAWINGS

FIG. 1 is a block diagram of one embodiment of an electronic device including a testing system.

FIG. 2 is a block diagram of function modules of the testing system included in the electronic device of FIG. 1.

FIG. 3 is a flowchart of one embodiment of a method of testing stability of updating firmware of a Baseboard Management Controller (BMC).

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

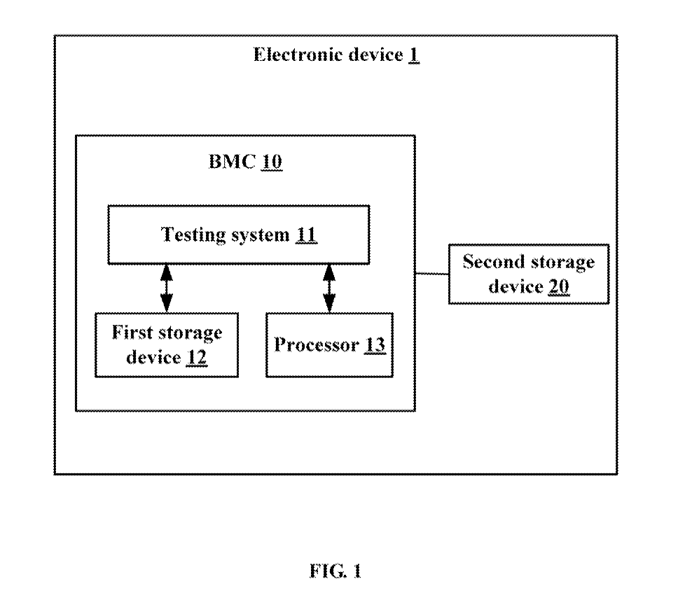

FIG. 1 is a block diagram of one embodiment of an electronic device 1 including a Baseboard Management Controller (BMC) 10. In this embodiment, the BMC 10 includes a testing system 11, a first storage device 12, and at least one processor 13. The electronic device 1 further includes a second storage device 20, which is connected to the BMC 10 through an Inter-Integrated Circuit (I2C) line.

In this embodiment, the electronic device 1 may be a personal computer or a server, the first storage device 12 is an Electrically Erasable Programmable Read-Only Memory (EEPROM), and the second storage device 20 is a Serial Peripheral Interface (SPI) flash.

The testing system 11 is used to test stability of updating firmware of the BMC 10. In this embodiment, the testing system 11 tests the stability of the BCM 10 by updating firmware of the BMC 10 repeatedly. The testing system 11 prestores original firmware data of the BMC 10 in the first storage device 12. The testing system 11 further prestores update data of the firmware in the second storage device 20.

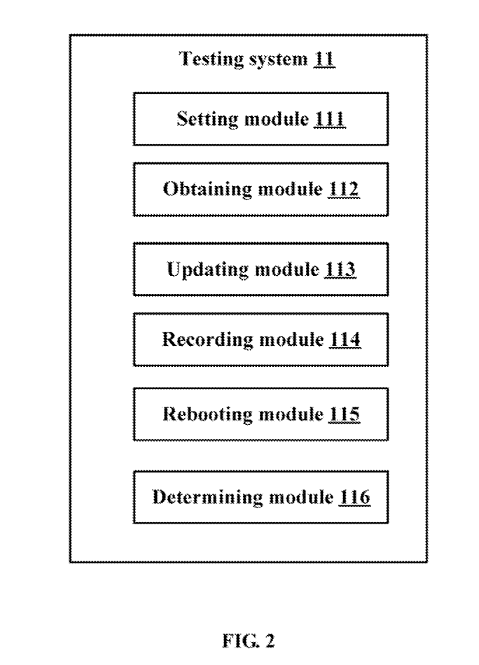

FIG. 2 is a block diagram of function modules of the testing system 10 included in the electronic device 1 of FIG. 1. In this embodiment, the testing system 10 may include a setting module 111, an obtaining module 112, an updating module 113, a recording module 114, a rebooting module 115, and a determining module 116. The modules 111-116 include computerized codes in the form of one or more programs that may be stored in the first storage device 12. The computerized code includes instructions that are executed by the at least one processor 13.

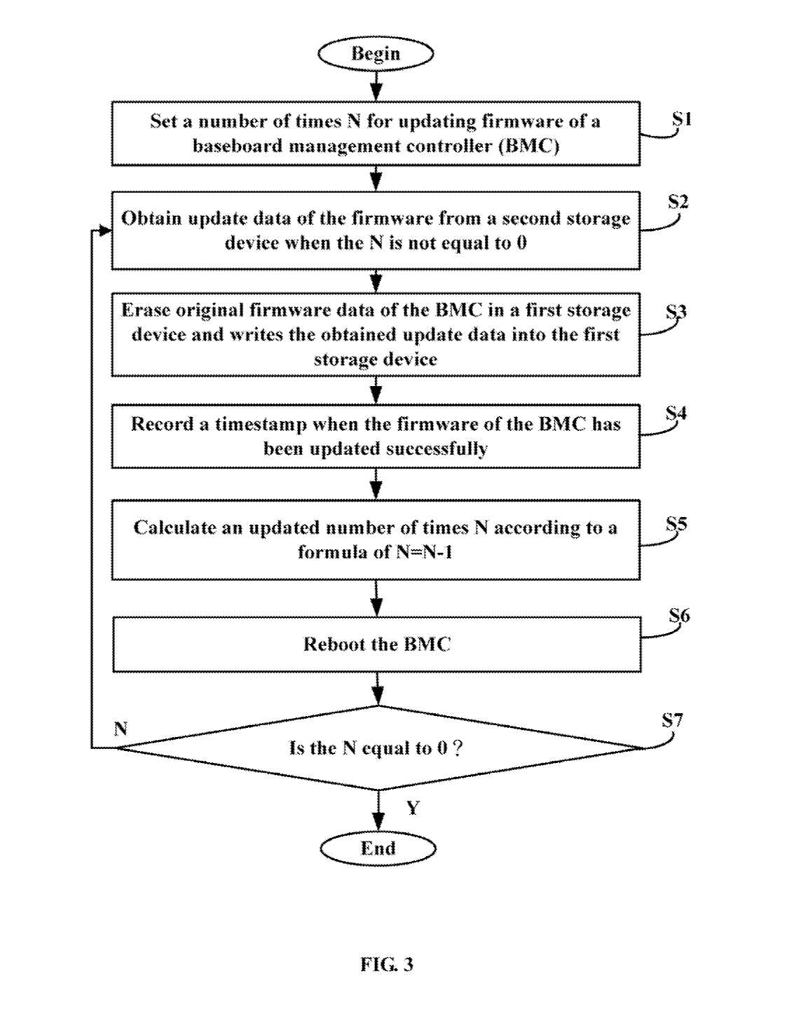

FIG. 3 is a flowchart of one embodiment of a method of testing stability of updating firmware of the BMC 10. Depending on the embodiment, additional steps may be added, others deleted, and the ordering of the steps may be changed.

In step S1, the setting module 111 sets a number of times N for updating the firmware of the BMC 10.

As the firmware of the BMC 10 can be continually updated for more times, the stability of the BMC 10 is better. The value of N is determined according to the need for stability of the BMC 10. In one embodiment, N may be equal to 20, 30, or another value.

In step S2, the obtaining module 112 obtains the update data of the firmware from the second storage device 20.

In step S3, the updating module 113 updates the firmware of the BMC 10 by erasing the original firmware data in the first storage device 12, and writing the obtained update data of the firmware into the first storage device 12. That is, the firmware of the BMC 10 has been updated successfully for one time.

In step S4, the recording module 114 records a timestamp when the firmware of the BMC 10 has been updated successfully.

In one embodiment, the recording module 114 records the timestamp by creating a system event log. The recording module 114 further stores the system event log in the second storage device 20. For example, when the firmware of the BMC 10 has been updated successfully for a first time at 2013 Dec. 5 15:30 pm, the recording module 114 creates a first system event log to record the firmware of the BMC 10 has been updated for the first time at 2013 Dec. 5 15:30 pm. The recording module 114 further stores the first system event log in the second storage device 20.

In step S5, the setting module 111 calculates an updated number of times according to a formula of “N=N−1”, and sets the updated number of times to be a current number of times N for updating the firmware of the BMC 10.

For example, if the setting module 111 sets the number of times (N=30) in step S1, and the firmware of the BMC 10 has been updated successfully for one time in step S3, then the setting module 111 in step S5 calculates the updated number of times according to the formula, and obtains the updated number of times (N=29). The setting module 111 further sets the updated number of times (N=29) to be the current number of times for updating the firmware of the BMC 10.

In step S6, the rebooting module 115 reboots the BMC 10.

In step S7, the BMC 10 performs initialization after step S6, the determining module 116 determines whether N is equal to 0 when the BMC 10 is initialized. If N is equal to 0, the procedure ends, if N is not equal to 0, then the procedure returns to step S2.

In other embodiments, the determining module 116 further determines whether the BMC 10 is qualified before ending the procedure.

In one embodiment, the determining module 116 determines whether the BMC 10 is qualified, by comparing an actual updating number of times with a predetermined standard value. If the actual updating number of times is more than or equal to the predetermined standard value, the determining module 106 determines the BMC 10 is qualified, otherwise, the determining module 116 determines the BMC 10 is not qualified.

For example, the determining module 116 determines the firmware of the BMC 10 has been updated successfully for 20 times, according to the system event logs in the second storage device 20. However, the actual number of times (i.e., 20) is less than the predetermined standard value (e.g., 25). Then the determining module 116 determines the BMC 10 is not qualified.

In another embodiment, the determining module 116 determines whether the BMC 10 is qualified, by verifying a time length each time updating the firmware of the BMC 10. When the time length each time updating the firmware of the BMC 10 is less than or equal to a predetermined test duration, the determining module 116 determines the BMC 10 is qualified, otherwise, the determining module 116 determines the BMC 10 is not qualified.

For example, the determining module 116 determines the firmware of the BMC 10 has been updated successfully for the predetermined number of times (e.g., 30 times), according to the number of system even logs stored in the second storage device 20.

However, the determining module 116 determines that the time length (e.g., more than 15 minutes) when the firmware of the BMC 10 updated for the sixth time, is greater than the predetermined test duration (e.g. 5 mins). Then the determining module 116 determines the BMC 10 is not qualified.

In one embodiment, the determining module 116 calculates the time length according to the system event logs in the storage device 20. For example, a fifth system event log records that the firmware of the BMC 10 is updated at 2013 Dec. 1 10:30 pm, and the sixth event log records that the firmware of the BMC 10 is updated at 2013 Dec. 1 10:45 pm, then the determining module 116 calculates the time length when the firmware of the BMC 10 updated for the sixth time is equal to 15 mins.

Although embodiments of the present disclosure have been specifically described, the present disclosure is not to be construed as being limited thereto. Various changes or modifications may be made to the present disclosure without departing from the scope and spirit of the present disclosure.

What is claimed is:

1. A method of testing stability of updating firmware of a baseboard management controller (BMC) of an electronic device, the electronic device comprising a first storage device that stores original firmware data of the BMC, a second storage device that stores update data of the firmware, and at least one processor, the method comprising:
setting a number of times N for updating the firmware of the BMC;
obtaining the update data of the firmware from the second storage device when the N is not equal to 0;
updating the firmware of the BMC by erasing the original firmware data and writing the obtained update data into the first storage device;
calculating an updated number of times according to a formula of N=N−1; and
rebooting the BMC.

2. The method of claim 1, further comprising:
determining whether the BMC is qualified by comparing an actual updating number of times with a predetermined standard value.

3. The method of claim 2, further comprising:
verifying a time length each time updating the firmware of the BMC, when the actual updating number of times is more or equal to the predetermined standard value.

4. The method of claim 1, further comprising:
recording a timestamp each time when the firmware of the BMC has been updated successfully.

5. The method of claim 1, wherein the second storage device is connected to the BMC through an Inter-Integrated Circuit (I2C) line.

6. An electronic device, comprising:
a baseboard management controller (BMC);
a first storage device storing original firmware data of the BMC;
a second storage device storing update data of the firmware;
at least one processor; and
the first storage device further storing a plurality of instructions, which, when executed by the processor, causes the processor to:
set a number of times N for updating the firmware of the BMC;
obtain the update data of the firmware from the second storage device when the N is not equal to 0;
update the firmware of the BMC by erasing the original firmware data and writing the obtained update data into the first storage device;
calculate an updated number of times according to a formula of N=N−1; and
reboot the BMC.

7. The electronic device of claim 6, wherein the plurality of instructions further causes the processor to:
determine whether the BMC is qualified by comparing an actual updating number of times with a predetermined standard value.

8. The electronic device of claim 7, wherein the plurality of instructions further causes the processor to:
verify a time length each time updating the firmware of the BMC, when the actual updating number of times is more or equal to the predetermined standard value.

9. The electronic device of claim 6, wherein the plurality of instructions further causes the processor to:
record a timestamp each time when the firmware of the BMC has been updated successfully.

10. The electronic device of claim 6, wherein the second storage device is connected to the BMC through an Inter-Integrated Circuit (I2C) line.

11. A non-transitory storage medium having stored thereon instructions that, when executed by a processor of an electronic device, causes the processor to perform a method of testing stability of updating firmware of a baseboard management controller (BMC) of the electronic device, the electronic device further comprising a first storage device that stores original firmware data of the BMC, and a second storage device that stores update data of the firmware, the method comprising:
setting a number of times N for updating the firmware of the BMC;
obtaining the update data of the firmware from the second storage device when the N is not equal to 0;
updating the firmware of the BMC by erasing the original firmware data and writing the obtained update data into the first storage device;
calculating an updated number of times according to a formula of N=N−1; and
rebooting the BMC.

12. The method of claim 11, further comprising:
determining whether the BMC is qualified by comparing an actual updating number of times with a predetermined standard value.

13. The method of claim 12, further comprising:
verifying a time length each time updating the firmware of the BMC, when the actual updating number of times is more or equal to the predetermined standard value.

14. The method of claim 11, further comprising:
recording a timestamp each time when the firmware of the BMC has been updated successfully.

15. The method of claim 11, wherein the second storage device is connected to the BMC through an Inter-Integrated Circuit (I2C) line.
